(19) United States
(12) Patent Application Publication
(10) Pub. No.: US 2024/0045058 A1
(43) Pub. Date: Feb. 8, 2024

(54) SIGNAL PROCESSING APPARATUS, SIGNAL PROCESSING METHOD, AND PROGRAM

(71) Applicant: SONY SEMICONDUCTOR SOLUTIONS CORPORATION, KANAGAWA (JP)

(72) Inventor: SATOSHI YAMADA, KANAGAWA (JP)

(21) Appl. No.: 18/264,449

(22) PCT Filed: Jan. 6, 2022
(86) PCT No.: PCT/JP2022/000162

§ 371 Date: Aug. 7, 2023

(30) Foreign Application Priority Data
Feb. 18, 2021 (JP) 2021-024314

(51) Int. Cl. G01S 17/08; G01S 7/4865

(52) U.S. Cl. CPC G01S 17/08; G01S 7/4865

(57) ABSTRACT

The present disclosure relates to a signal processing apparatus, a signal processing method, and a program that make it possible to achieve further enhancement of the functionality.

An embedded data separator extracts embedded data embedded in phase data supplied from an iTOF sensor, and an OPD calculation section calculates OPD data indicative of a detected light amount necessary for execution of automatic exposure from the phase data. A depth data processing section executes a signal process for the phase data to acquire depth data indicative of a depth to a target object that is a target of distance measurement. A transmission processing section transmits the embedded data, the OPD data, and the depth data in an output format that complies with the MIPI format. The present technology can be applied, for example, to a distance measurement system that includes an iTOF sensor.

### TECHNICAL FIELD

The present disclosure relates to a signal processing apparatus, a signal processing method, and a program, and particularly to a signal processing apparatus, a signal processing method, and a program that make it possible to further enhance the functionality.

### BACKGROUND ART

Conventionally, in an iTOF (indirect Time Of Flight) sensor by which a displacement in phase is detected on the basis of flight time of light to perform distance measurement, the MIPI (Mobile Industry Processor Interface) format is used for transmission of phase data to a device in a later stage such as an application processor.

For example, PTL 1 discloses a distance measurement apparatus in which an interface circuit that complies with the MIPI is used for a communication interface section for outputting calculated distance measurement data to an external host IC.

### CITATION LIST

### Patent Literature

### [PTL 1]

Japanese Patent Laid-Open No. 2020-148682

### SUMMARY

### Technical Problem

Incidentally, enhancement in functionality of a distance measurement system including an iTOF sensor has proceeded, and it is considered that not only transmission of such phase data as described above but also transmission of depth data, OPD (Optical Detector) data, and so forth is demanded. However, since the conventional MIPI format does not support transmission of depth data, OPD data, or the like, it is required to enhance the functionality in such a manner that transmission of such data as described above becomes possible.

The present disclosure has been made in view of such a situation as described above, and it is an object of the present disclosure to make it possible to achieve further enhancement of the functionality.

### Solution to Problem

A signal processing apparatus according to one aspect of the present disclosure includes a depth data processing section that executes a signal process for phase data supplied from an iTOF sensor, to acquire depth data indicative of a depth to a target object that is a target of distance measurement, and a transmission processing section that transmits the depth data in a predetermined output format.

A signal processing method or a program according to one aspect of the present disclosure includes executing a signal process for phase data supplied from an iTOF sensor, to acquire depth data indicative of a depth to a target object that is a target of distance measurement, and transmitting the depth data in a predetermined output format.

In one aspect of the present disclosure, a signal process is executed for phase data supplied from an iTOF sensor, to acquire depth data indicative of a depth to a target object that is a target of distance measurement, and the depth data is transmitted in a predetermined output format.

### BRIEF DESCRIPTION OF DRAWINGS

FIG. 1 is a diagram depicting a conventional MIPI format.

FIG. 2 is a block diagram depicting an example of a configuration of an embodiment of a distance measurement system to which the present technology is applied.

FIG. 3 is a diagram depicting an example of an output format for outputting depth data and OPD data from a signal processing section.

FIG. 4 is a diagram depicting an example of a Depth pixel format and an OPD pixel format.

FIG. 5 is a flow chart illustrating a signal process of the signal processing section.

FIG. 6 is a block diagram depicting an example of a configuration of an embodiment of a computer to which the present technology is applied.

### DESCRIPTION OF EMBODIMENTS

In the following, specific embodiments to which the present technology is applied are described in detail with reference to the drawings.

<Conventional MIPI Format>

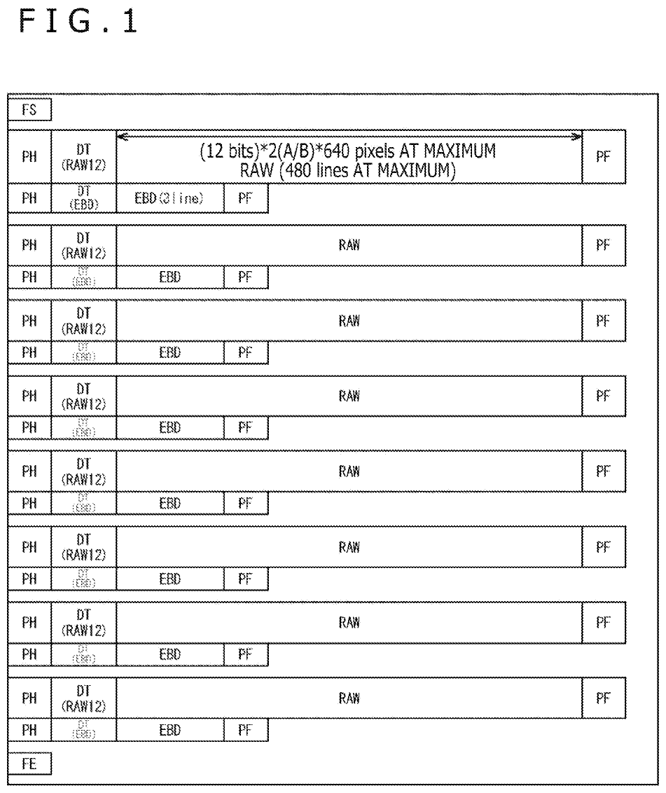

FIG. 1 depicts a conventional MIPI format.

As depicted in FIG. 1, the conventional MIPI format used to output phase data from an iTOF sensor is prescribed such that two sets of four pieces of phase data (RAW), totaling eight pieces of phase data, are mapped to one frame of the MIPI. However, such a conventional MIPI format does not support mapping of multiple different pieces of data such as depth data and OPD data to the MIPI format of the same frame.

<Example of Configuration of Distance Measurement System>

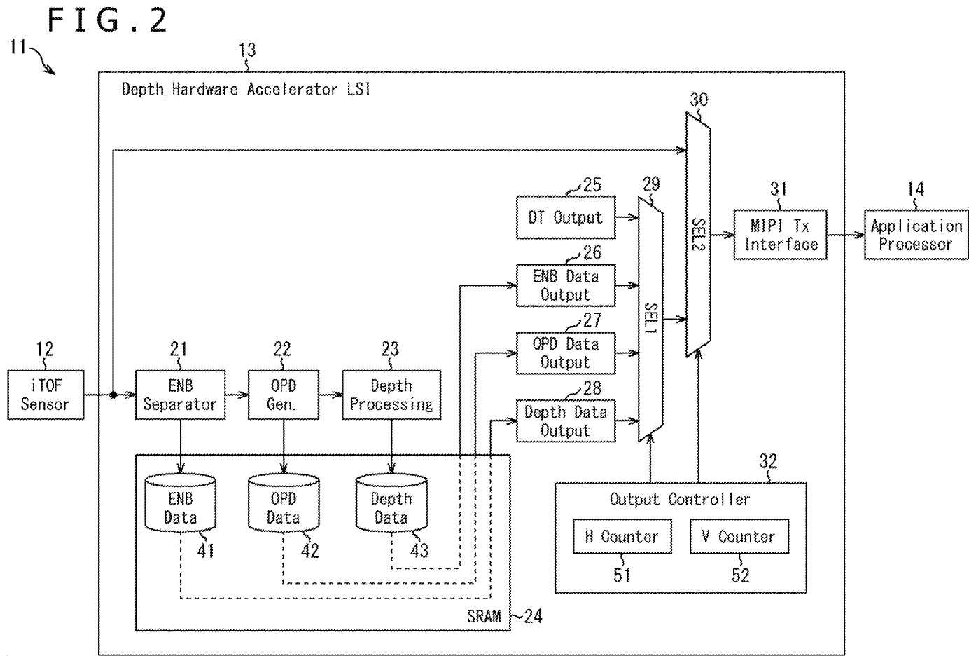

FIG. 2 is a block diagram depicting an example of a configuration of an embodiment of a distance measurement system 11 to which the present technology is applied.

As depicted in FIG. 2, the distance measurement system 11 includes an iTOF sensor 12, a signal processing apparatus 13, and an application processor 14.

The iTOF sensor 12 performs distance measurement by irradiating a target object that is a target of distance measurement with a pulsed laser beam and detecting a phase shift of a pulse in reflected light of the laser beam, and supplies phase data indicative of the phase to the signal processing apparatus 13. For example, the iTOF sensor 12 can transmit the phase data to the signal processing apparatus 13 according to the MIPI format depicted in FIG. 1.

The signal processing apparatus 13 is, for example, depth hardware accelerator LSI (Large Scale Integration) designed for exclusive use for applying a signal process to the phase data supplied from the iTOF sensor 12. Further, the signal processing apparatus 13 transmits the phase data supplied from the iTOF sensor 12 or depth data and OPD data obtained as a result of the signal process for the phase data to the application processor 14.

The application processor 14 executes various applications using the data supplied from the signal processing apparatus 13. Further, the application processor 14 includes an interface circuit (MIPI Rx Interface) that complies with the MIPI for receiving the data transmitted thereto from the signal processing apparatus 13.

As depicted in the figure, the signal processing apparatus 13 includes an ENB separator 21, an OPD calculation section 22, a depth data processing section 23, a storage section 24, a data type outputting section 25, an ENB data outputting section 26, an OPD data outputting section 27, a depth data outputting section 28, a first selection section 29, a second selection section 30, an MIPI transmission interface 31, and an output controller 32. The storage section 24 includes an ENB data saving section 41, an OPD data saving section 42, and a depth data saving section 43. The output controller 32 has a horizontal counter 51 and a vertical counter 52.

Phase data supplied from the iTOF sensor 12 to the signal processing apparatus 13 is inputted to the ENB separator 21 and the second selection section 30.

The ENB separator 21 extracts embedded data embedded in the phase data supplied from the iTOF sensor 12 and saves the extracted data into the ENB data saving section 41 of the storage section 24. Then, the ENB separator 21 supplies the phase data obtained after the embedded data is extracted, to the OPD calculation section 22.

The OPD calculation section 22 calculates, from the phase data supplied thereto from the ENB separator 21, OPD data indicative of a detected light amount that is to be necessary for execution of automatic exposure (AE) in a later stage, and saves the calculated OPD data into the OPD data saving section 42 of the storage section 24. Then, the OPD calculation section 22 supplies the phase data supplied thereto from the ENB separator 21, to the depth data processing section 23.

The depth data processing section 23 executes a Depth signal process for the phase data supplied from the OPD calculation section 22, to acquire depth data indicative of the depth to a target object that is a target of distance measurement. For example, the depth data processing section 23 is implemented by hardware designed for exclusive use for a signal process for acquiring depth data, and can execute the Depth signal process at a higher speed. Then, the depth data processing section 23 saves the depth data acquired as a processing result of the Depth signal process into the depth data saving section 43 of the storage section 24.

The storage section 24 includes, for example, an SRAM (Static Random Access Memory), and saves various kinds of data such as embedded data, OPD data, and depth data and temporarily stores the data.

The data type outputting section 25 outputs a data type (DT) indicative of a data type of each of the embedded data, the OPD data, and the depth data to the first selection section 29 according to a parameter set in advance, at a timing according to a control signal of the output controller 32.

The ENB data outputting section 26 reads out embedded data saved in the ENB data saving section 41 of the storage section 24 and outputs the read-out data to the first selection section 29 at a timing according to a control signal of the output controller 32.

The OPD data outputting section 27 reads out OPD data saved in the OPD data saving section 42 of the storage section 24 and outputs the read-out data to the first selection section 29 at a timing according to a control signal of the output controller 32.

The depth data outputting section 28 reads out depth data saved in the depth data saving section 43 of the storage section 24 and outputs the read-out data to the first selection section 29 at a timing according to a control signal of the output controller 32.

The first selection section 29 selects any of the data type, the embedded data, the OPD data, and the depth data according to a control signal of the output controller 32 and outputs the selected data to the second selection section 30. It is to be noted that the data type, the embedded data, the OPD data, and the depth data are hereinafter referred to also as internal generation data as needed.

The second selection section 30 selects either one of the phase data supplied from the iTOF sensor 12 to the signal processing apparatus 13 or the internal generation data supplied thereto via the first selection section 29 and outputs the selected data to the MIPI transmission interface 31. For example, the second selection section 30 can select data to be required by an application that is executed by the application processor 14.

The MIPI transmission interface 31 supplies the phase data or the internal generation data supplied thereto via the second selection section 30, to the application processor 14 in the later stage, in such an output format that the data is mapped in compliance with the MIPI format.

The output controller 32 counts, by the horizontal counter 51 thereof, the number of pixels in the horizontal direction in the data in the MIPI format and counts, by the vertical counter 52 thereof, the number of pixels in the vertical direction in the data in the MIPI format. Then, the output controller 32 supplies control signals at timings according to the count values in the horizontal direction and the vertical direction to the data type outputting section 25, the ENB data outputting section 26, the OPD data outputting section 27, and the depth data outputting section 28. Further, the output controller 32 supplies control signals for controlling selection by the first selection section 29 and the second selection section 30 to the first selection section 29 and the second selection section 30, respectively.

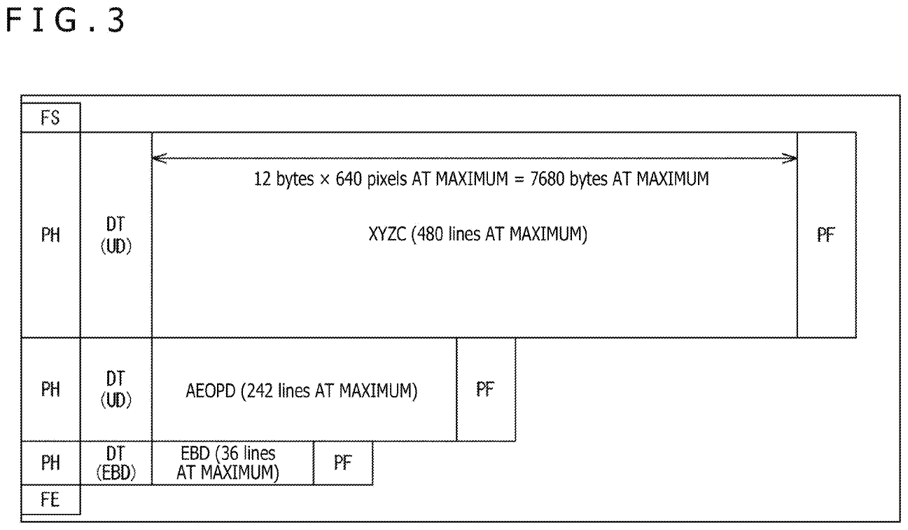

The signal processing apparatus 13 is configured in such a manner as described above and can perform mapping of multiple different pieces of data such as depth data and OPD data to the MIPI format of the same frame. That is, the signal processing apparatus 13 can transmit the internal generation data (depth data, OPD data, and embedded data) in such an output format as depicted in FIG. 3.

In the output format depicted in FIG. 3, a frame start FS is added to the top, depth data, OPD data, and embedded data are deployed, and a frame end FE is added to the tail end.

The depth data includes data for 480 lines at its maximum in which data of each pixel is configured from XYZC values, and has a data amount of 7680 bytes at its maximum (=12 bytes×640 pixels at its maximum). Further, prior to the depth data, a packet header PH and a data type DT (UD) are deployed, and subsequent to the depth data, a packet footer PF is deployed. For example, the depth data includes data of 640×480 pixels at its maximum.

The OPD data includes data of 242 lines at its maximum; prior to the OPD data, a packet header PH and a data type DT (UD) are deployed, and subsequent to the OPD data, a packet footer PF is deployed. For example, the OPD data includes 242 lines (=(120 lines at its maximum+1 line)×2 fmod), which are 160×121 pixels×2 fmod at its maximum.

The embedded data includes data of 36 lines at its maximum, and a packet header PH and a data type DT (EBD) are deployed prior to the embedded data, and a packet footer PF is deployed subsequent to the embedded data. For example, the embedded data includes data of 36 lines (=4 lines at its maximum (input)×8 phase+4 lines at its maximum (internal)).

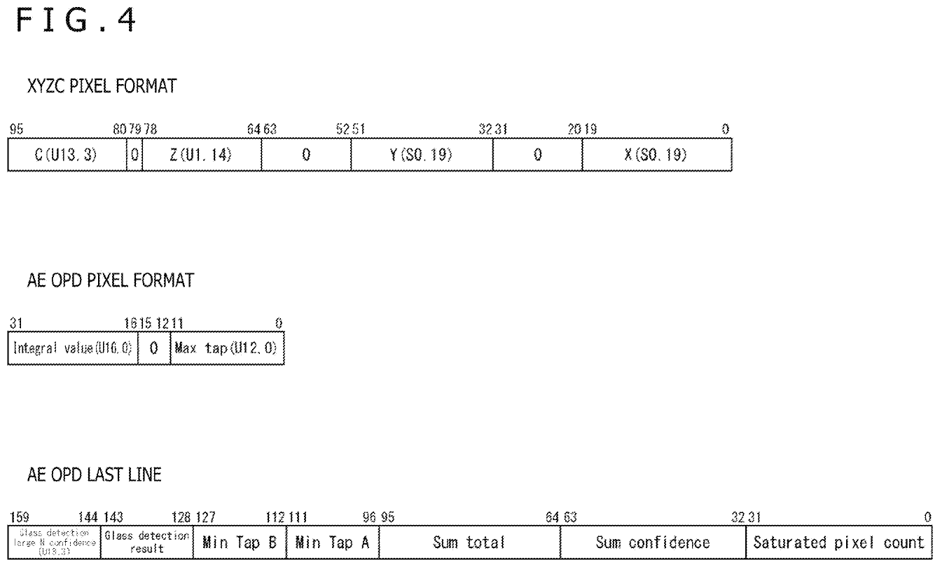

FIG. 4 depicts an example of a Depth pixel format and an OPD pixel format.

In the Depth pixel format, XYZC values configuring depth data are deployed according to such an XYZC pixel format as depicted in the figure.

In the OPD pixel format, as depicted in the figure, pieces of data are deployed according to an AE OPD pixel format except the last line, and in the last line, pieces of data are deployed according to an AE OPD last line. It is to be noted that, except the AE OPD last line, all lines to the line end are reserved.

<Example of Processing in Signal Process>

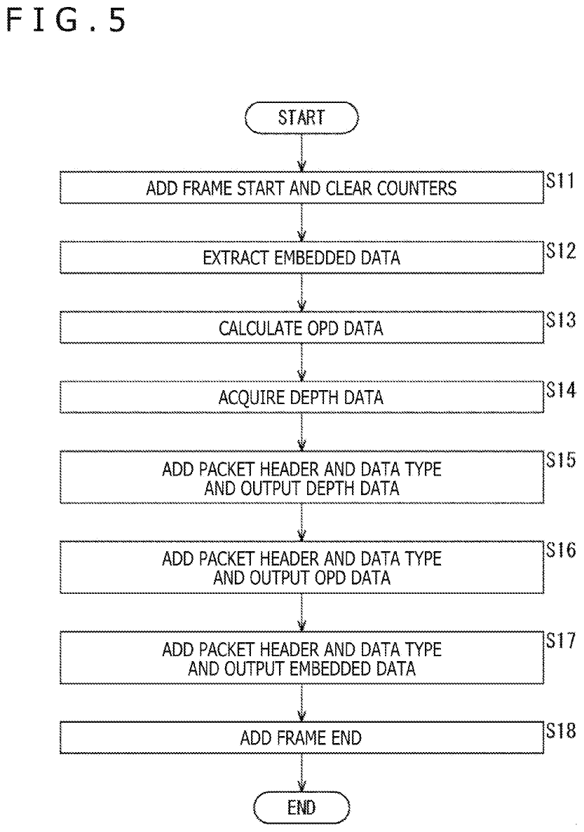

A signal process of the signal processing apparatus 13 that outputs internal generation data in such an output format as depicted in FIG. 3 is described with reference to a flow chart depicted in FIG. 5.

In step S11, the MIPI transmission interface 31 first adds a frame start FS of the output format, according to a frame start FS inputted thereto from the iTOF sensor 12. Then, the output controller 32 clears the count values of the horizontal counter 51 and the vertical counter 52.

In step S12, the ENB separator 21 extracts embedded data embedded in phase data supplied thereto from the iTOF sensor 12 and saves the extracted data into the ENB data saving section 41 of the storage section 24.

In step S13, the OPD calculation section 22 calculates OPD data from the phase data supplied thereto via the ENB separator 21 and saves the calculated data into the OPD data saving section 42 of the storage section 24.

In step S14, the depth data processing section 23 executes a Depth signal process using the phase data supplied thereto via the OPD calculation section 22 and saves depth data acquired as a result of the process into the depth data saving section 43 of the storage section 24.

In step S15, the MIPI transmission interface 31 adds a packet header PH to the top of a packet, and the data type outputting section 25 adds a data type DT (UD). The depth data outputting section 28 reads out depth data for one packet from the depth data saving section 43 of the storage section 24 according to the count value of the horizontal counter 51 of the output controller 32 and supplies the read-out data to the MIPI transmission interface 31 via the first selection section 29 and the second selection section 30. The MIPI transmission interface 31 outputs the packet header PH, the data type DT (UD), the depth data for one packet, and the packet footer PF. Then, this process is performed repeatedly the number of times corresponding to the number of required packets according to the count value of the vertical counter 52 of the output controller 32.

In step S16, the MIPI transmission interface 31 adds a packet header PH to the top of the packet, and the data type outputting section 25 adds a data type DT (UD). The OPD data outputting section 27 reads out OPD data for one packet from the OPD data saving section 42 of the storage section 24 according to the count value of the horizontal counter 51 of the output controller 32 and supplies the read-out data to the MIPI transmission interface 31 via the first selection section 29 and the second selection section 30. The MIPI transmission interface 31 outputs the packet header PH, the data type DT (UD), the OPD data for one packet, and the packet footer PF. Then, this process is performed repeatedly the number of times corresponding to the number of required packets according to the count value of the vertical counter 52 of the output controller 32.

In step S17, the MIPI transmission interface 31 adds a packet header PH to the top of the packet, and the data type outputting section 25 adds a data type DT (EBD). The ENB data outputting section 26 reads out ENB data for one packet from the ENB data saving section 41 of the storage section 24 according to the count value of the horizontal counter 51 of the output controller 32 and supplies the read-out data to the MIPI transmission interface 31 via the first selection section 29 and the second selection section 30. The MIPI transmission interface 31 outputs the packet header PH, the data type DT (EBD), the ENB data for one packet, and the packet footer PF. Then, this process is performed repeatedly the number of times corresponding to the number of required packets according to the count value of the vertical counter 52 of the output controller 32.

In step S18, the MIPI transmission interface 31 adds a frame end FE to the last, with which outputting of one frame is ended.

Since the signal processing apparatus 13 executes such a signal process as described above, depth data and OPD data can be transmitted to the application processor 14 in an output format in which they are mapped to the MIPI format. More specifically, the signal processing apparatus 13 can use as a trigger the frame start in the MIPI format inputted thereto from the iTOF sensor 12, to map, using the count value of the horizontal counter 51, multiple different pieces of data such as phase data, embedded data, depth data, and OPD data into the same frame of the MIPI and transmit the resultant data to the application processor 14 in the later stage.

Since the signal processing apparatus 13 obtains depth data and OPD data in such a manner, the functionality of the distance measurement system 11 as a whole can further be enhanced. In other words, the distance measurement system 11 is configured such that the application processor 14 in the later stage does not perform the Depth signal process while the signal processing apparatus 13 can execute the Depth signal process at a high speed. This makes it possible to achieve, for example, reduction of the frame delay.

Further, since the signal processing apparatus 13 can perform, by the second selection section 30 thereof, selection of one of phase data or internal generation data, it is also possible to, for example, transmit phase data in the conventional MIPI format. It is to be noted that, as an alternative to the configuration in which the iTOF sensor 12 and the signal processing apparatus 13 are provided independently of each other, for example, by incorporating the circuit of the signal processing apparatus 13 into a logic section of the iTOF sensor 12, it is possible to form them in one chip, and it is also possible to output depth data and OPD data in the output format of the present embodiment from the iTOF sensor 12 of the one chip.

<Example of Configuration of Computer>

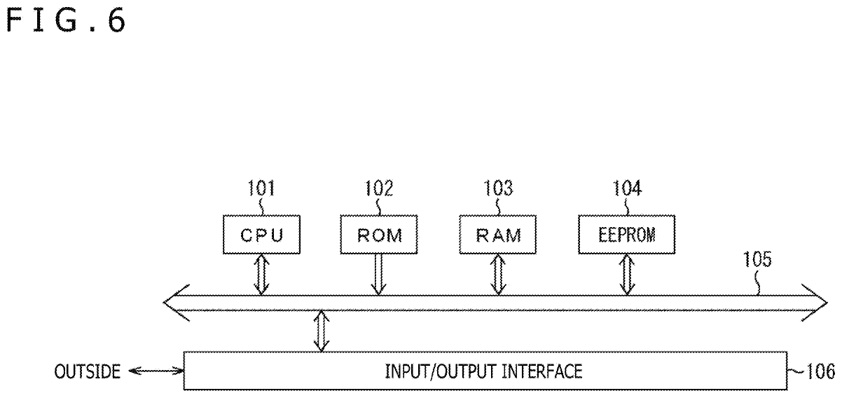

FIG. 6 is a block diagram depicting an example of a hardware configuration of a computer that executes the series of processes described above by a program.

In the computer, a CPU (Central Processing Unit) 101, a ROM (Read Only Memory) 102, a RAM (Random Access Memory) 103, and an EEPROM (Electronically Erasable and Programmable Read Only Memory) 104 are connected to one another by a bus 105. An input/output interface 106 is connected further to the bus 105 and is connected to the outside.

In the computer configured in such a manner as described above, the CPU 101 loads and executes a program stored, for example, in the ROM 102 and the EEPROM 104 into the RAM 103 via the bus 105 to perform the series of processes described above. Further, the program to be executed by the computer (CPU 101) can be written in advance in the ROM 102 or can be installed or updated from the outside into the EEPROM 104 via the input/output interface 106.

Here, in the present specification, processes executed according to a program by the computer may not necessarily be performed in time series according to the order described in the flow chart. That is, the processes executed according to a program by the computer also include processes that are executed in parallel or individually (for example, parallel processes or processes by an object).

Further, the program may be processed by a single computer (processor) or may be distributed to and processed by multiple computers. Moreover, the program may be transferred to and executed by a computer at a remote place.

Further, in the present specification, the term system signifies a set of multiple components (devices, modules (parts), or the like), and it does not matter whether or not all components are included in the same housing. Accordingly, multiple devices that are accommodated in separate housings and are connected to each other by a network as well as a single device including multiple modules accommodated in a single housing are systems.

Further, for example, a configuration described hereinabove as a single device (or processing unit) may otherwise be configured as multiple devices (or processing units). Conversely, configurations described as multiple devices (or processing units) hereinabove may be configured collectively as a single device (or processing unit). Further, to the configuration of each device (or each processing unit), a configuration other than those described above may naturally be added. Moreover, as long as the configuration or action of the entire system is substantially the same, part of the configuration of a certain device (or processing unit) may be included in the configuration of a different device (or a different processing unit).

Further, for example, the present technology can adopt a configuration for cloud computing by which a single function is shared and cooperatively processed by multiple devices via a network.

Further, for example, the program described hereinabove can be executed by any device. In this case, it is sufficient if the device has a necessary function (functional block or the like) and can obtain necessary information.

Further, for example, each step described hereinabove in connection with the flow chart can not only be executed by a single device but also be shared and executed by multiple devices. Moreover, in a case where one step includes multiple processes, the multiple processes included in the one step can not only be executed by a single device but also be shared and executed by multiple devices. In other words, it is also possible to execute multiple processes included in one step as processes in multiple steps. Conversely, it is also possible to execute processes described as multiple steps collectively as a single step.

It is to be noted that the program to be executed by the computer may be such that the processes in the steps that describe the program are executed in time series according to the order described in the present specification, or alternatively, are executed in parallel or individually at a necessary timing such as when they are called. In short, unless inconsistent, the processes in the steps may be executed in a sequence different from the sequence described hereinabove. Further, the processes in the steps that describe this program may be executed in parallel to processes of a different program or may be executed in combination with processes of a different program.

It is to be noted that the multiple technologies described in the present specification can each be carried out independently and solely unless inconsistent. Naturally, freely selected ones of the multiple technologies can be carried out in combination. For example, it is also possible to carry out part or all of the technology described in connection with any of the embodiments, in combination with part or all of the technology described in connection with a different one of the embodiments. Further, it is also possible to carry out part or all of a freely selected one or ones of the technologies described hereinabove, together with a different technology that is not described hereinabove.

<Combination Examples of Configuration>

It is to be noted that the present technology can also adopt the following configurations.

(1)

A signal processing apparatus including:
a depth data processing section that executes a signal process for phase data supplied from an iTOF (indirect Time Of Flight) sensor, to acquire depth data indicative of a depth to a target object that is a target of distance measurement; and
a transmission processing section that transmits the depth data in a predetermined output format.
   (2)

The signal processing apparatus according to (1) above, in which
the depth data processing section is implemented by hardware designed for exclusive use for the signal process for acquiring the depth data.
   (3)

The signal processing apparatus according to (1) or (2) above, in which
the output format complies with an MIPI (Mobile Industry Processor Interface) format.
   (4)

The signal processing apparatus according to any of (1) to (3) above, further including:
an OPD calculation section that calculates OPD (Optical Detector) data indicative of a detected light amount necessary for execution of automatic exposure from the phase data, in which
the transmission processing section transmits the OPD data in the output format.
   (5)

The signal processing apparatus according to any of (1) to (4) above, further including:
an embedded data separator that extracts embedded data embedded in the phase data, in which
the transmission processing section transmits the embedded data in the output format.
   (6)

The signal processing apparatus according to any of (1) to (5) above, further including:
a selection section that selects either one of the phase data supplied from the iTOF sensor or the depth data acquired by the depth data processing section and supplies the selected data to the transmission processing section.
   (7)

A signal processing method performed by a signal processing apparatus that performs a signal process, the signal processing method including:
executing a signal process for phase data supplied from an iTOF (indirect Time Of Flight) sensor, to acquire depth data indicative of a depth to a target object that is a target of distance measurement; and
transmitting the depth data in a predetermined output format.
   (8)

A program for causing a computer of a signal processing apparatus that performs a signal process to execute a signal process including:
executing a signal process for phase data supplied from an iTOF (indirect Time Of Flight) sensor, to acquire depth data indicative of a depth to a target object that is a target of distance measurement; and
transmitting the depth data in a predetermined output format.

It is to be noted that the embodiment is not restricted to the embodiments described above, and the embodiments can be altered in various manners without departing from the subject matter of the present disclosure. Further, the advantageous effects described in the present specification are illustrative only and are not restrictive, and other advantageous effects may be achieved.

### REFERENCE SIGNS LIST

11: Distance measurement system
12: iTOF sensor
13: Signal processing apparatus
14: Application processor
21: ENB separator
22: OPD calculation section
23: Depth data processing section
24: Storage section
25 Data type outputting section
26: ENB data outputting section
27: OPD data outputting section
28: Depth data outputting section
29: First selection section
30 Second selection section
31: MIPI transmission interface
32: Output controller
41: ENB data saving section
42: OPD data saving section
43: Depth data saving section
51: Horizontal counter
52: Vertical counter

1. A signal processing apparatus comprising:
a depth data processing section that executes a signal process for phase data supplied from an iTOF (indirect Time Of Flight) sensor, to acquire depth data indicative of a depth to a target object that is a target of distance measurement; and
a transmission processing section that transmits the depth data in a predetermined output format.

2. The signal processing apparatus according to claim 1, wherein
the depth data processing section is implemented by hardware designed for exclusive use for the signal process for acquiring the depth data.

3. The signal processing apparatus according to claim 1, wherein
the output format complies with an MIPI (Mobile Industry Processor Interface) format.

4. The signal processing apparatus according to claim 1, further comprising:
an OPD calculation section that calculates OPD (Optical Detector) data indicative of a detected light amount necessary for execution of automatic exposure from the phase data, wherein
the transmission processing section transmits the OPD data in the output format.

5. The signal processing apparatus according to claim 1, further comprising:
an embedded data separator that extracts embedded data embedded in the phase data, wherein
the transmission processing section transmits the embedded data in the output format.

6. The signal processing apparatus according to claim 1, further comprising:
a selection section that selects either one of the phase data supplied from the iTOF sensor or the depth data acquired by the depth data processing section and supplies the selected data to the transmission processing section.

7. A signal processing method performed by a signal processing apparatus that performs a signal process, the signal processing method comprising:
executing a signal process for phase data supplied from an iTOF (indirect Time Of Flight) sensor, to acquire depth data indicative of a depth to a target object that is a target of distance measurement; and
transmitting the depth data in a predetermined output format.

8. A program for causing a computer of a signal processing apparatus that performs a signal process to execute a signal process comprising:
executing a signal process for phase data supplied from an iTOF (indirect Time Of Flight) sensor, to acquire depth data indicative of a depth to a target object that is a target of distance measurement; and
transmitting the depth data in a predetermined output format.
